(19) United States
(12) Patent Application Publication
(10) Pub. No.: US 2003/0005607 A1
(43) Pub. Date: Jan. 9, 2003

(54) Lighted protable and fixed paintstation and easel

(76) Inventor: David Joseph O'Hanlon, Miller Place, NY (US)

Correspondence Address: David J. O' Hanlon, 466 Miller Place Road, Miller Place, NY, 11764, US

(21) Appl. No.: 10/127,946

(22) Filed: Apr. 23, 2002

Related U.S. Application Data
(63) Continuation-in-part of application No. 09/229,088, filed on Jan. 11, 1999, now abandoned.
(63) Continuation-in-part of application No. 09/567,887, filed on May 10, 2000, now abandoned.

(51) Int. Cl. G02B 27/02

(52) U.S. Cl. 40/367

(57) ABSTRACT

A work station for illuminating non-opaque materials and the non-opaque artist's media upon their surface. Interior light sources are arranged to be enclosed within the work station behind a plurality of transferable non-opaque materials and an encasement or mold for which they are designed. The energized light illuminates and enhances non-opaque artist's media upon non-opaque material surfaces. A further object of the work station is the novel method of mounting non-opaque artwork. Grooved fasteners allow the non-opaque materials (2) and non-opaque medium display (3) to be inserted or removed from the work stations base (7) and (4). The two workplaces separate from the holding tray (11) and lock together to form a carry case (20).

### RELATED APPLICATIONS

This application is a continuation-in-part of pending application Ser. No. 09/229,088 filed Jan. 11, 1999, which application is not abandoned, and a filed continuation-in-part for Ser. No. 09/567,887 filed May 10, 2000, which application is abandoned.

This invention applies to work stations primarily used for the illumination of materials laid upon their surface.”

### BACKGROUND

Work stations that include: architectural and landscape design light tables, light boxes, printing industry devices, and tables for graphic artists as well as devices for children are common.

However, a significant enhancement of non-opaque artwork is made when non-opaque materials and the non-opaque artists media upon their surface are directly illuminated by an interior light source.

More specifically, this proper usage of mounting and interactively applying artwork, enhances endless art possibilities by consumer product re-use.

Significantly, the use of oil and acrylic paints, fluorescent paints, gels, films, inks, and all other artist's media applicable to the use of art as it is directly applied to non-opaque materials, combined with proper and direct applications and illumination, add visual appeal.

Further, these devices provide a place to make and create artwork, transport the artwork efficiently, and due to the size of the non-opaque material, use the same artwork in devices for displaying.

### PRIOR ART

Relative to this patent are the prior patented art of display boxes. This art describes the same variations that exist in lighted work tables. It is made of many different light boxes with various constructions. However, none have the same design principle or method of use as heretofore discussed. U.S. Pat. No. 5,664,352 by Beckman, dated Sep. 9, 1997, has composite construction which does not allow the same insertion and removal of media. In addition, the use of poster paper wherein the illuminated easels use non-opaque materials. Secondly, photographic non-opaque poster prints are utilized without using non-opaque artists media. U.S. Pat. No. 4,318,237 by Hicks, dated Mar. 9, 1982, discusses a light display unit. This unit includes further use of extra components. More specifically, it makes use of a transparent panel. Respectively also, rather than applying artistic media in an instantaneous manner, the photographs are unspontaneously chemically affixed by darkroom chemicals at an earlier time. U.S. Pat. No. 4,185,407 by Lamb, dated Jan. 29, 1980, discusses “translucent objects, such as drawings and water-color prints.” However, the illuminated easels use a frame structure for inserting or removing non-opaque materials for added visual appeal of said adorned non-opaque materials. It relates the specimens used for the particular device to water-colored items (A water-colored item relates to that done on water-color paper), and selected minerals, stamps, and coins.

U.S. Pat. No. 4,261,125 by Rappaport, dated Apr. 14, 1981, uses transparencies, however there is no relationship to artist's media adorning non-opaque materials. U.S. Pat. No, 4,242,821 by Mcneil, dated Jul. 25, 1978, has a different construction for pictorial display. U.S. Pat. No. 3,707,792 by Mabrey, et. Al., dated Jan. 2, 1973, illuminates building directions.

U.S. Pat. No. 1,915,236 by Messner et. al. discusses an outdoor illuminated display device. U.S. Pat. No. 2,638,533 by Zobian has a differently constructed base. U.S. Pat. No. 3,610,918 by Barlow is a different novelty device.

The amount of references cited of illuminated display devices, parallels the variety of existing patents. Descriptions heretofore are of those of the most similarities to the light boxes used in work stations. The present station solves the easy insertion or removal of non-opaque material into a fixed or transportable encasement or mold. In addition, it shows non-opaque artist's media upon the surface of non-opaque materials, along the use of the devices illumination, adds visual appeal.

Consequently, the novel arrangements possible with non-opaque materials in transportable or fixed work stations abound due to the nature of geometry.

### OBJECTS OF THE INVENTION

The objective of using the present work station is to provide an interior light source and encasement to display, illuminate, enhance, and interactively apply non-opaque artist's media directly upon non-opaque material surfaces. The direct application and non-opaque materials insertion or removal allows said non-opaque materials cleaning and re-use or change.

Additionally, molded non-opaque materials replaces the need for cabinet design, and allows for any geometric shape encompassing a light source, the visually appealing illumination effect of the direct application of non-opaque artist's media.

Significantly, the art stations ability to transform from a head-to-head table into a carrying case, makes its use more advantageous. Moreover, an A frame easel described, folds, showing an objective of using multiple form encasements that are additionally easily stored or carried. In this A frame configuration, the combination work station for artwork and display device comprises two tables of the easel are positioned in an A frame configuration wherein the two tables stand upright and are oriented obliquely together and joined at their respective tops by a common edge.

A work station that illuminates and provides illumination of non-opaque artist's media as they are applied, said non-opaque materials readily useable for the insertion into the display device, said work station being adorned, enhancing materials surfaces.

Described hereinafter is a novel display arrangement and work station for illuminating non-opaque materials and the non-opaque artist's media applied directly upon the said non-opaque materials surface. In addition, it allows for the direct use of displaying non-opaque materials as they are being illuminated. Accordingly, the work station comprises: two encasement arrangement; center container; interior light sources attached to illuminate such said encasements; channels for the insertion and removal of non-opaque materials; two pieces of non-opaque materials; grooved fasteners for the insertion and removal of non-opaque materials; grooved fasteners for the insertion and removal of non-opaque medium displays; two non-opaque medium displays; channels for the insertion and removal of the container into the encasements; fasteners; and a handle.

Significantly, the first object of the work station is the illumination produced by an interior light source contained within an encasement of mold and non-opaque materials. Non-opaque artist's media including: oil paints; acrylic paints; fluorescent paints; gels; films; inks; crayons; and all others applicable to use in art directly applied to non-opaque materials, are illuminated as they are properly applied, and the light diffuses through their matter.

Another object is to provide a work station encasement or mold that allows the easy insertion or removal of non-opaque materials. Inclusively, this option allows different encasement or mold size, shape, dimensions, and different number, size, and shape non-opaque materials may be used. In addition, the way the non-opaque materials are inserted or removed and held in place may change due to encasement or mold and non-opaque materials shape and dimension. However, the principle of easy insertion and removal of the non-opaque materials is the secondary objective of the invention, and described further by way of examples using drawing figures and seven particular workstation configurations. The third object is to fundamentally provide a work station to illuminate non-opaque medium as they are applied to the surface of the non-opaque materials.

A further object is to provide a readily transportable work station.

A still further object is provide a collapsible work station.

A yet further object is to provide a display device that has an economically feasible manufacturing cost.

Moreover, as part of these objective values, including a device of one panel for manufacture, provides better economical feasibility as well as easy construction, inheriting properties of a new and useful invention.

Further advantages of the preferred and alternate embodiments will appear in the later description.

### SUMMARY OF THE INVENTION

The objective of using the present work station is to provide an interior light source and encasement to display, illuminate, enhance, and provide direct applications of non-opaque artists media adorning non-opaque material surfaces. The direct application and non-opaque materials insertion or removal, allows for the non-opaque materials cleaning and re-use or change.

Additionally, molded non-opaque materials replaces the need for cabinet design, and allows for any geometric shape encompassing a light source, the visually appealing illumination effect of the direct application of non-opaque mediums.

Significantly, the work stations ability to be transformed from a head-to head table into a carry case makes its use advantageous.

Moreover, an A frame easel work station can collapse for easy storage or carrying.

A work station that illuminates and provides said illumination during the application of non-opaque mediums, and its ready use for the insertion into a display device or removal form cleaning or change, significantly enhances its use.

A combination work station for artwork and display device for an artist's artwork produced thereat, said combination work station and display device comprising: a frame having a light source behind at least one unadorned non-opaque material surface to illuminate said non-opaque material surface, having a set of artist's working tools including artistic media to be applied upon said unadorned surface of said at least one non-opaque material surface of said combination work station for artwork and display device, to adorn said non-opaque material surface with spontaneously created artwork thereon, said frame having a predetermined width and a predetermined height, said at least one frame having an opening having a predetermined length and a predetermined width, said frame having at least one grooved fastener for the insertion or removal of said unadorned non-opaque material surface, said unadorned non-opaque material surface being receptive to adorning with artwork spontaneously created by the artist, said frame further having at least one source of electrical current powering said light source, said at least one interior light source energizing and illuminating said non-opaque material surface and said artistic media applied spontaneously thereon. The combination work station for artwork and display device described wherein said at least one frame includes a non-illuminated outer-opaque portion of said non-opaque material surface.

The combination work station for artwork and display device as in claim wherein said frame is at least one table.

The combination work station for artwork and display device described in claim wherein said at least one table of said combination work station comprises two tables juxtaposed to one another, and an attached container in the center, said tables of said combination work station transforming from a head-to-head table into a carrying case. This is shown further by drawings and description of the Preferred Embodiment.

The combination work station for artwork and display device wherein said frame is an easel. This shown further by drawings and descriptions of Alternate Embodiment 1.

The combination work station for artwork and display device wherein said easel is height adjustable.

The combination work station for artwork and display device further comprising a combination chair and table, wherein said combination work station for artwork and display device comprises an illuminated chair and said table, said table including at least one insert-able non-opaque material surface therein. This is shown further by drawings and descriptions of Alternate Embodiment 2.

The combination work station for artwork and display device further comprising at least one work place with at least one container holding said artist's tools therein.

The combination work station for artwork and display device further comprising a stand supporting said work station, forming an easel, said work place having a plurality of containers and flat surface providing a place for non-opaque mediums and accessories for adorning said non-opaque material. This is shown further by drawings and descriptions of Alternate Embodiment 3.

The combination work station for artwork and display device wherein said work station is portable. The combination work station for artwork and display device further comprising a portable body for use as a work station on any flat surface, said work place being a single desk-like design with an interior container and a handle for transport. This is shown further by drawings and descriptions of Alternate Embodiment 4.

The combination work station for artwork and display device further comprising a plurality of non-opaque material sides, and a carry-able light encasement. This is shown further by drawings and descriptions of Alternate Embodiment 5.

The combination work station wherein said easel further comprises a stand holding said easel above the ground, said easel being an A frame, said frame collapsing closed. This is shown further by drawings and description of Alternate Embodiment 6.

The combination work station for artwork and display device wherein said device is moldable.

The combination work station for artwork and display device wherein said source of electrical current comprises an electrical housing holding a lamp-holder, said lamp holder holding a lamp, said lamp energized by a switch alternately turning on and off said current provided from said electrical current source through a wire having a plug connect-able to said electrical current source.

The combination work station for artwork and display device wherein said source of electrical current comprises an electrical housing including a lamp socket holding a lamp having a ballast therein, said lamp energized by a switch alternately turning on and off said current provided from said electrical current source through a wire having a plug connect-able to said electrical current source.

The combination work station for artwork and display device wherein said source of electrical current comprises a battery operated lighting unit with/without electrical jack.

The combination work station for artwork and display device wherein said source of electrical current comprises a plurality of light-emitting diode batteries powering a plurality of light emitting diodes.

A method for displaying artistic media upon illuminated non-opaque materials, comprising the steps of: applying artistic media directly upon the surface of said non-opaque materials; providing an electrical current to an interior light source to diffract light by transmission from the interior to the exterior surface of the said non-opaque materials, wherein the illumination of the said artistic media directly applied to the outer surface of the non-opaque material, diffracts further, providing said illumination of said artistic media.

The method wherein said artistic media directly applied upon said non-opaque materials are non-opaque media.

The combination work station for artwork and display device for an artist's artwork produced thereat wherein said artists working tools are selected from the group consisting of: oil paint; acrylic paint; fluorescent paint; inks; gels; crayons; magic markers; gouache; transparencies; colored tissue paper; brushes; pens; clear fluorescent paint; vinyl acrylic binder; adhesives.

The combination work station for artwork and display device wherein said non-opaque material surface is a panel.

The combination work station for artwork and display device wherein said non-opaque material surface is an artists canvas.

The combination work station for artwork and display device wherein said non-opaque material surface is translucent plastic.

The combination work station for artwork and display device wherein said non-opaque material surface is transparent plastic.

The combination work station for artwork and display device for an artist's artwork produced thereat wherein said interior light sources are selected from the group consisting of: fluorescent light; incandescent light; strobe light; black light; at least one light emitting diode; at least one low-wattage light.

The combination work station for artwork and display device further comprising at least one artists' stencil prescribing at least one outlines for using artists' mediums thereon.

The combination work station for artwork and display device wherein said stencil has at least one extensions locking said stencil from lateral movement when said stencil is placed on said non-opaque material surface.

The combination work station for artwork and display device wherein said stencil is placed within said at least one frame.

The combination work station for artwork and display device wherein a plurality of numbers are provided within said outline of said at least one stencil.

The combination work station for artwork and display device wherein a plurality of color codes are provided within said outline of said at least one stencil.

The combination work station for artwork and display device wherein a swivel base is provided to rotate and show artwork.

The combination work station for artwork and display device wherein a support component allows the said display device to hang out from a wall.

The combination work station for artwork and display device wherein a support component allows the said display device to hang down from a ceiling.

The combination work station for artwork and display device wherein said interior light source is removable from said frame.

The combination work station for artwork and display device wherein said at least one non-opaque material surface comprises a plurality of interchangeable non-opaque material surfaces, providing change or replacing said non-opaque material surface with a different non-opaque material surface. The combination work station for artwork and display device wherein said at least one non-opaque material surface comprises a plurality of interchangeable non-opaque material surfaces, providing a means to change and re-use each of said non-opaque material surfaces.

As discussed in this summary, the invention can be made in any geometric form capable with cabinetry or molding and non-opaque or opaque materials. Therefore, the description and illustrations provide one preferred and four alternate embodiments that may by used. However, they are prospective in nature, and elements in the construction of the present display device may be made within the values described in claims.

### DESCRIPTION OF THE DRAWINGS

FIG. 18—Perspective drawing of the Preferred Embodiment.

FIG. 19—Side view of closed case of Preferred Embodiment.

FIG. 20—Exploded view of Preferred Embodiment.

FIG. 21—sectional view of one encasement of Preferred Embodiment.

FIG. 22—Perspective view of Alternate Embodiment 1.

FIG. 23—Side view of Alternate Embodiment 1.

FIG. 24—Rear view of Alternate Embodiment 1.

FIG. 25—Side breakaway view of Alternate Embodiment 1 encasement.

FIG. 26—Perspective view of Alternate Embodiment 2.

FIG. 27—Perspective view of chair of Alternate Embodiment 2.

FIG. 28—Side breakaway view of chair of Alternate Embodiment 2.

FIG. 29—Bottom view of Alternate Embodiment 2.

FIG. 30—Side breakaway view of Alternate Embodiment 2.

FIG. 31—Perspective view of Alternate Embodiment 3.

FIG. 32—Side view of Alternate Embodiment 3.

FIG. 33—Perspective exploded view of Alternate Embodiment 3.

FIG. 34—Perspective view of Alternate Embodiment 4.

FIG. 35—Perspective rear view of Alternate Embodiment 4.

FIG. 36—Perspective view of Alternate Embodiment 5.

FIG. 37—Perspective view of Alternate Embodiment 6.

FIG. 38—Side view of Alternate Embodiment 6.

FIG. 39—Secondary side view of Alternate Embodiment 6.

### DETAILED DESCRIPTION

### Preferred Embodiment

Referring to FIG. 18 of the Preferred Embodiment 101, plates 102 and 103 are inserted into grooved fasteners held by each interior side of top member's 108, 109, and 110. Sides 107, and 104 with respective opposite side 104A, form frame structure encasement for non-opaque material illumination. Legs 106 provide height.

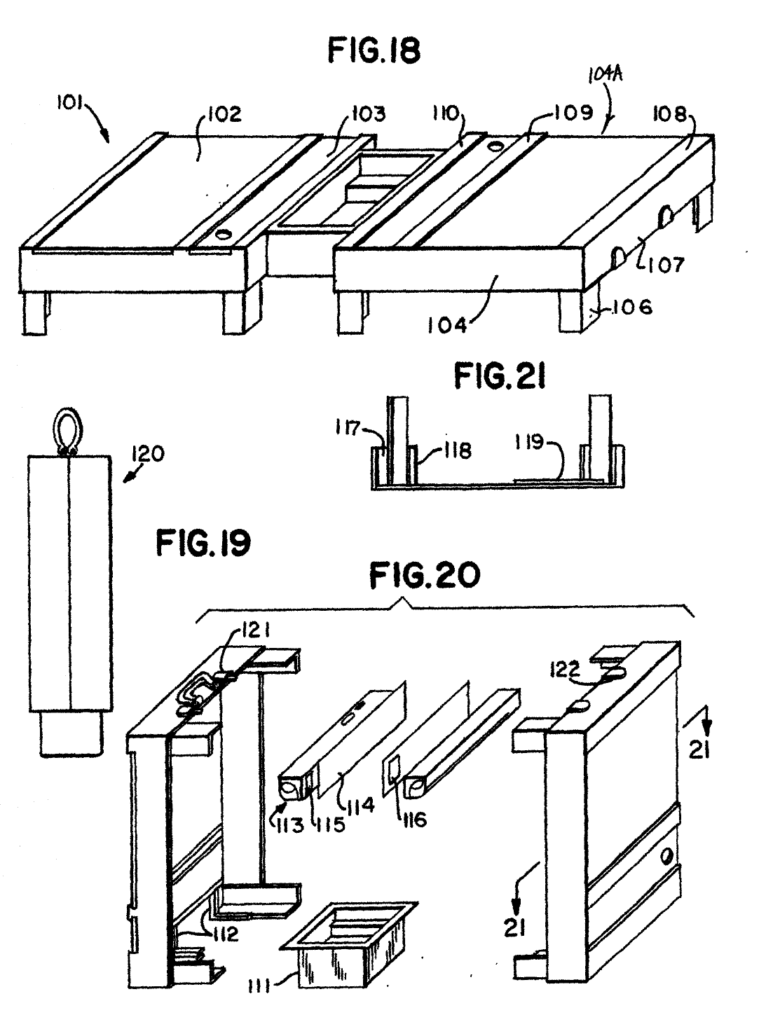

Referring to FIG. 20 container 111 slides into channels 112. Light source 113 attaches to members 114 by means of hook and loop fasteners 115 and 116. Buckles 121 and 122 close carrying case FIG. 19, 120.

Referring to FIG. 21 channels 118 provide holding of 111 form FIG. 20. Channels 119 hold the art material. Offset member 117 allow legs to attach and connect with other encasement.

### Example of Alternate Embodiment 1

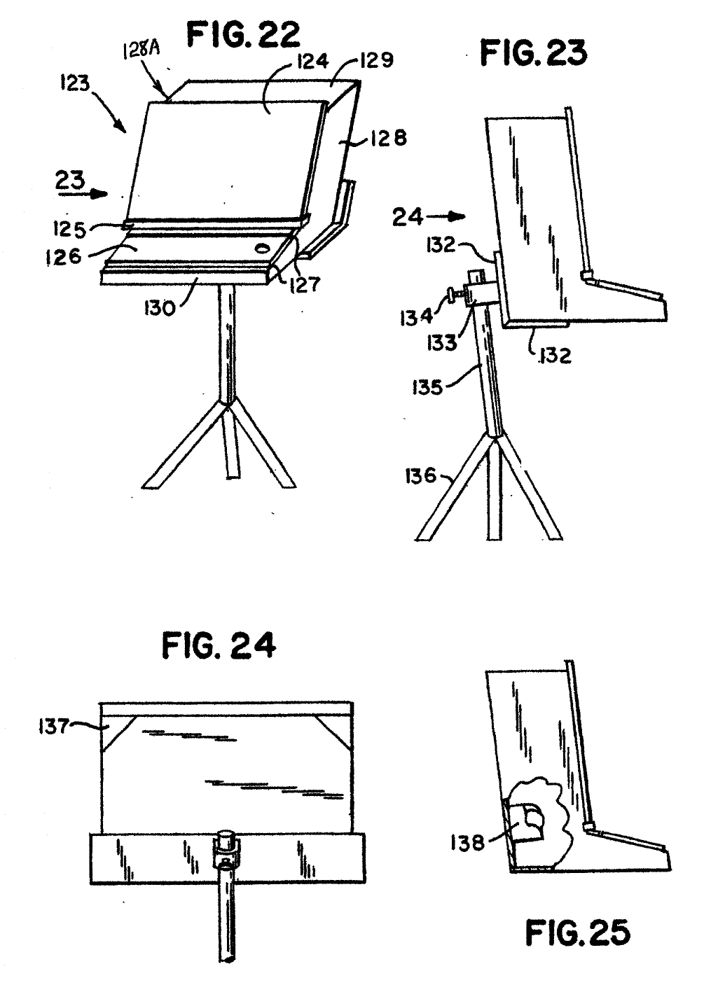

Referring to FIG. 22 of Alternate Embodiment 1, non-opaque material surfaces 124 and 126 are inserted into grooved fasteners 125 and 127. A frame structure composed of joining 129, 128 and respective opposite side 128A, as well as front 130, is used to enclose and form an encasement around a light for non-opaque material illumination. Referring to FIG. 24 of Alternate Embodiment 1, a height adjustable support stand is shown by joining holder 131 and 132, to collar and pin 133 and 134 respectively with support stand rod 135 and legs 136.

Referring to FIG. 24, corner elements 137 attach to the corners. FIG. 25 shows light source 138.

### Example of Alternate Embodiment 2

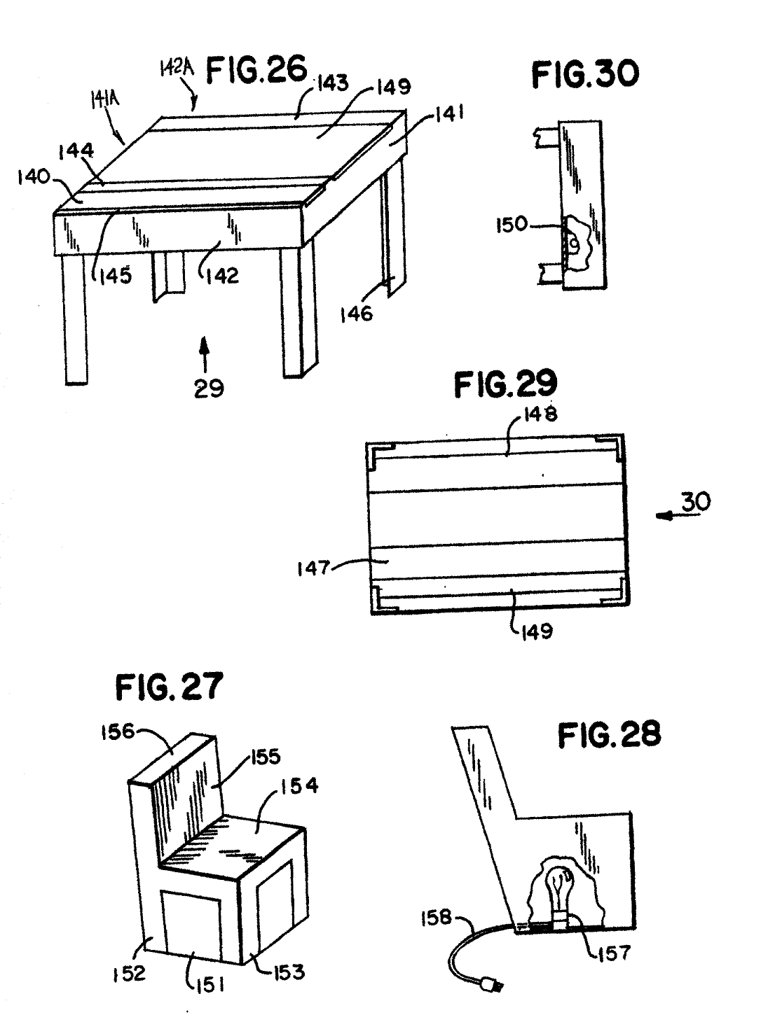

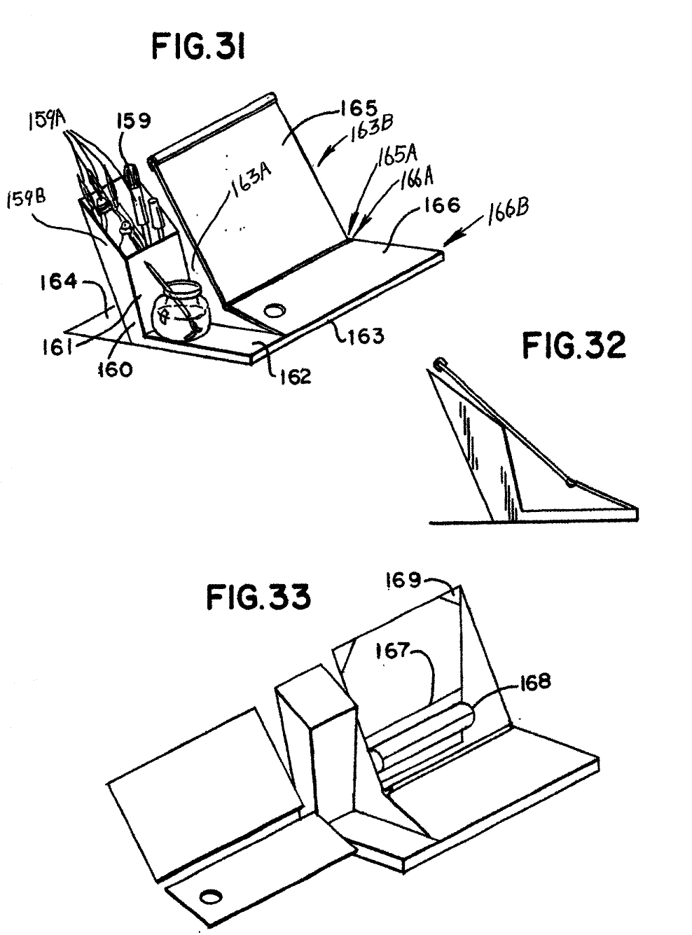

Referring to FIG. 26 of Alternate embodiment 2, a table design, non-opaque material surfaces 139 and 140 are inserted into grooved fasteners held on the interior of each top member 143, 144, and 145. Sides 141 and 142 along with their respective opposite sides 141A and 142A, form frame encasement for housing an interior light and for non-opaque material illumination. Legs 146 provide height.

Referring to FIG. 29, 148 and 149 are channels. 147 is a rear panel. FIG. 30 shows light source 150.

Referring to FIG. 27 members 151, 152, 153, 154, 155, 156, attach to form chair encasement. FIG. 28 shows light source 157 and 158.

### Example of Alternate Embodiment 3

Referring to FIG. 31 of Alternate Embodiment 3, non-opaque material surfaces 165 and 166 are inserted into respective grooves 165A, 166A, and 166B. Front 163 joins respective sides 163A and 163B, forming a frame encasement for housing an interior light and for non-opaque material illumination. Flat surface 162 adjoins container sides 159, 160, and 161. A flat piece 164 stabilizes the device from tipping backwards. Referring to FIG. 33, light 168 is attached to member 167. Corner elements 169 provide strength.

### Example of Alternate Embodiment 4

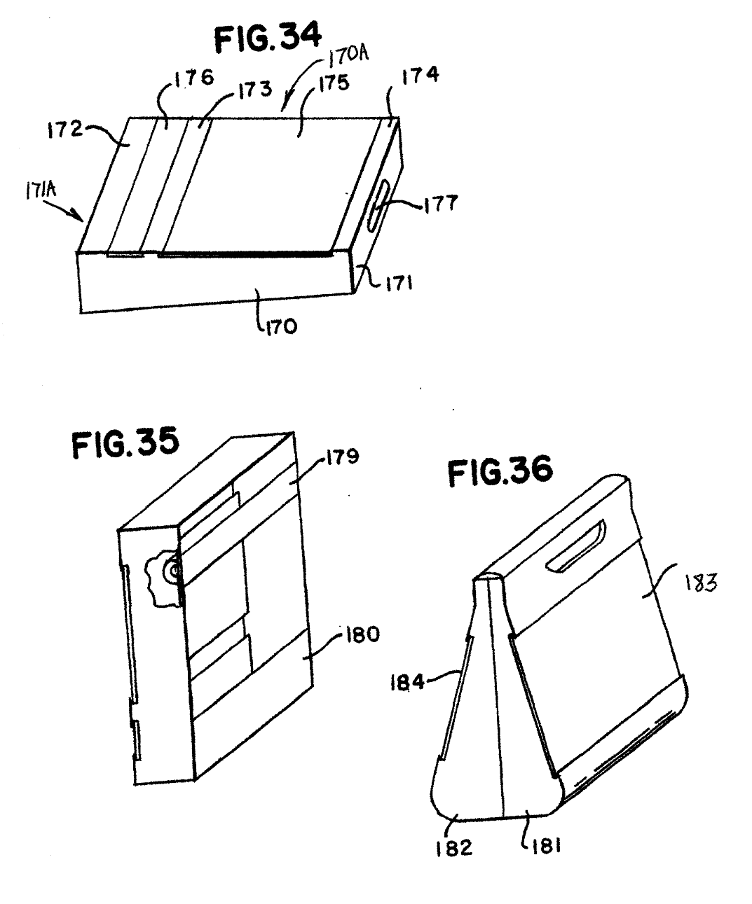

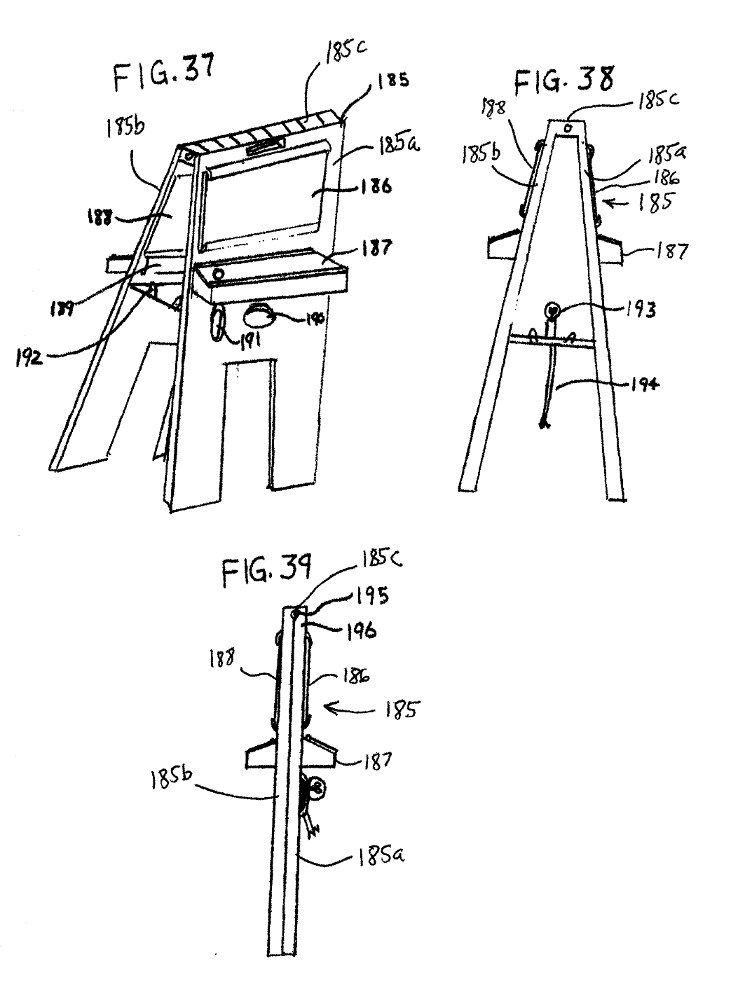

Referring to FIG. 34 of Alternate Embodiment 4, a frame encasement is formed when joining sides 170, 171, and their respective opposite sides 170A and 171A. Non-opaque material surfaces 175 and 176 are inserted into grooved fasteners held at each interior side of top members 172, 173, and 174. The encasement encloses a light source wherein illumination of each respective non-opaque material occurs. A handle 177 for transporting is shown.

FIG. 35 shows a breakaway view of light source, and rear 179. In addition, a container is completed with strip 180.

### Example of Alternate Embodiment 5

Referring to FIG. 36 of Alternate Embodiment 5, two molded sides with molded grooves 181 and 182 respectively, fasten non-opaque material surfaces 183 and 184 to form an example of a molded frame to provide non-opaque material illumination.

### Example of Alternate Embodiment 6

Referring to FIG. 37 of Alternate Embodiment 6, an A frame easel is described, which folds, showing an objective of using multiple form encasements that are additionally easily stored or carried. In this A frame configuration, the combination work station for artwork and display device comprises two tables 185a and 185b of the easel 185 are positioned in an A frame configuration wherein the two tables 185a and 185b stand upright and are oriented obliquely together and joined at their respective tops by a common edge 185c. Molded frame 185 receives in preformed grooves, non-opaque materials 186 and 187. Rearwardly, an opening shows back of non-opaque material panel 188, respective opposite side of 186. Additionally, transparent panel 189 is shown closing container for non-opaque artist's media while still providing illumination to non-opaque material respective opposite side of 187. Holes 190 and 191 allow interior light source and cord wrap, 192, to pass through for collapsing said molded frame easel 185.

Referring to FIG. 38, interior light source 193 and cord 194 are shown.

Referring to FIG. 39, formed hinge closes molded frame 196.

### Claims

The detailed description gives a preferred embodiment and six examples of work stations. However, the ability to change or modify using the media described heretofore, and additional media that is related to the novelty of the work station, leave novel arrangement that abound due to the nature of geometry and ability to work with both opaque and non-opaque materials in the construction of such said work stations.

Consequently, the novelties described and structured in the following claims, evidently should not limit the construction or the nature of the novelty. Changes could come in a variety of ways: modifications; deletions; and substitutes. These changes made of the described art station, may be made by skilled artisans, without varying the principles of the present invention.

The following are the claims that make the present invention described heretofore novel, adaptable, and usable in many shapes and forms:

I claim:

1. (Amended claim from “Lighted Frame”) A combination work station for artwork and display device for an artist's artwork produced thereat, said combination work station and display device comprising:
i) an open frame having a light source behind only one frame panel, said frame panel having only one single uncovered unadorned non-opaque material surface,
ii) a set of artist's working tools including artistic media to be applied upon said single uncovered unadorned non-opaque material surface of said only one frame panel of said combination work station for artwork and display device, to adorn said single uncovered non-opaque material surface with spontaneously created artwork thereon,
iii) said frame having a predetermined width and a predetermined height,
iv) said at least one frame having an opening having a predetermined length and a predetermined width;
v) said frame having at least one grooved fastener for the insertion or removal of said unadorned non-opaque material surface, said unadorned non-opaque material surface being receptive to adorning: with artwork spontaneously created by the artist,
vi) said frame further having at least one source of electrical current powering said light source,
vii.)said at least one interior light source energizing and illuminating said only one single uncovered non-opaque material surface of said only one panel and said artistic media applied spontaneously thereon.

2. The combination work station for artwork and display device as in claim 1 wherein said at least one frame includes a non-illuminated outer-opaque portion of said non-opaque material surface.

3. The combination work station for artwork and display device as in claim 1 wherein said frame is at least one table.

4. (Amended and Allowed claim) A combination work station for artwork and display device for an artist's artwork produced thereat, said combination work station and display device comprising:
i) an encasement having light source behind at least on unadorned non-opaque material surface to illuminate said non-opaque material surface,
ii) a set of artist's working tools including artistic media to be applied upon said unadorned surface of said at least one non-opaque material surface of said combination work station for artwork and display device, to adorn said non-opaque material surface with spontaneously created artwork thereon,
iii) said encasement having a predetermined width and a predetermined height,
iv) said at least on encasement having an opening having a predetermined length and a predetermined width;
v)said encasement supporting said unadorned non-opaque material surface, said unadorned non-opaque material surface being receptive to adorning with artwork spontaneously created by; the artist,
vi) said encasement further having at least one source of electrical current powering said light source,
vii) said at least on interior light source energizing and illuminating said non-opaque material surface and said artistic media applied spontaneously thereon,
viii) wherein said encasement is at least one table,
ix) wherein said at least one table of said combination work station comprises two tables juxtaposed to one another, and an attached container in the center, said tables of said combination work station transforming from a head-to-head table into a carrying case.
(Old claim 4) The combination work station for artwork and display device as in claim 1 wherein said at least one table of said combination work station comprises two tables juxtaposed to one another, and an attached container in the center, said tables of said combination work station transforming from a head-to-head table into a carrying case.

5. The combination work station for artwork and display device as in claim 1 wherein said frame is an easel.

6. The combination work station for artwork and display device as in claim 5 wherein said easel is height adjustable.

7. The combination work station as in claim 6 wherein said easel further comprises a stand holding said easel above the ground.

8. The combination work station for artwork and display device as in claim 7 wherein said two tables of said easel are positioned in an A frame configuration comprising said two tables being oriented obliquely together and joined at their respective tops by a common edge.

9. The combination work station for artwork and display device as in claim 8 wherein said frame collapses closed.

10. The combination work station for artwork and display device as in claim 1 further comprising a combination chair and table, wherein said combination work station for artwork and display device comprises an illuminated chair and said table, said table including at least one insert-able non-opaque material surface therein.

11. The combination work station for artwork and display device as in claim 1 further comprising at least one work place with at least one container holding said artist's tools therein.

12. The combination work station for artwork and display device as in claim 11 further comprising a stand supporting said work station, forming an easel, said work place having a plurality of containers and flat surface providing a place for non-opaque mediums and accessories for adorning said non-opaque material.

13. The combination work station for artwork and display device as in claim 1 wherein said work station is portable.

14. The combination work station for artwork and display device as in claim 13 further comprising a portable body for use as a work station on any flat surface, said work place being a single desk-like design with an interior container and a handle for transport.

15. The combination work station for artwork and display device as in claim 13 further comprising a plurality of non-opaque material sides, and a carry-able light encasement.

16. The combination work station for artwork and display device as in claim 1 wherein said device is moldable.

17. The combination work station for artwork and display device as in claim 1 wherein said source of electrical current comprises an electrical housing holding a lamp-holder, said lamp holder holding a lamp, said lamp energized by a switch alternately turning on and off said current provided from said electrical current source through a wire having a plug connect-able to said electrical current source.

18. The combination work station for artwork and display device as in claim 1 wherein said source of electrical current comprises an electrical housing including a lamp socket holding a lamp having a ballast therein, said lamp energized by a switch alternately turning on and off said current provided from said electrical current source through a wire having a plug connect-able to said electrical current source.

19. The combination work station for artwork and display device as in claim 1 wherein said source of electrical current comprises a battery operated lighting unit with/without electrical jack.

20. The combination work station for artwork and display device as in claim 1 wherein said source of electrical current comprises a plurality of light-emitting diode batteries powering a plurality of light emitting diodes.

21. A method for displaying artistic media upon illuminated non-opaque materials, comprising the steps of:
i.) applying artistic media directly upon the surface of said non-opaque materials;
ii.) providing an electrical current to an interior light source to diffract light by transmission from the interior to the exterior surface of the said non-opaque materials, wherein the illumination of the said artistic media directly applied to the outer surface of the non-opaque material, diffracts further, providing said illumination of said artistic media.

22. The method as in claim 21 wherein said artistic media directly applied upon said non-opaque materials are non-opaque media.

23. The combination work station for artwork and display device as in claim 1 for an artist's artwork produced thereat wherein said artists working tools are selected from the group consisting of:
i.) oil paint;
ii.)acrylic paint;
iii.)fluorescent paint;
iv.)inks;
v.)gels;
vi.)crayons;
vii.)magic markers;
viii.)gouache;
x.)transparencies;
xi.)colored tissue paper;
xii) brushes;
xiii) pens;
xiv.) clear fluorescent paint;
xv.) vinyl acrylic binder;
xvi.) adhesives.

24. The combination work station for artwork and display device as in claim 1 wherein said non-opaque material surface is a panel.

25. The combination work station for artwork and display device as in claim 1 wherein said non-opaque material surface is an artists canvas.

26. The combination work station for artwork and display device as in claim 1 wherein said non-opaque material surface is translucent plastic.

27. The combination work station for artwork and display device as in claim 1 wherein said non-opaque material surface is transparent plastic.

28. The combination work station for artwork and display device as in claim 1 for an artist's artwork produced thereat wherein said interior light sources are selected from the group consisting of:
i.)fluorescent light;
ii.)incandescent light;
iii.)strobe light;
iv.)black light.
v.)at least one light emitting diode;
vi.)at least one low-wattage light.

29. The combination work station for artwork and display device as in claim 1 further comprising at least one artists' stencil prescribing at least one outlines for using artists' mediums thereon.

30. The combination work station for artwork and display device as in claim 29 wherein said stencil has at least one extensions locking said stencil from lateral movement when said stencil is placed on said non-opaque material surface.

31. The combination work station for artwork and display device as in claim 29 wherein said stencil is placed within said at least one frame.

32. The combination work station for artwork and display device as in claim 29 wherein a plurality of numbers are provided within said outline of said at least one stencil.

33. The combination work station for artwork and display device as in claim 29 wherein a plurality of color codes are provided within said outline of said at least one stencil.

34. The combination work station for artwork and display device as in claim 1 wherein a swivel base is provided to rotate and show artwork.

35. The combination work station for artwork and display device as in claim 1 wherein a support component allows the said display device to hang out from a wall.

36. The combination work station for artwork and display device as in claim 1 wherein a support component allows the said display device to hang down from a ceiling.

37. The combination work station for artwork and display device as in claim 1 wherein said interior light source is removable from said frame.

38. The combination work station for artwork and display device as in claim 1 wherein said at least one non-opaque material surface comprises a plurality of interchangeable non-opaque material surfaces, providing a means to change and replace said non-opaque material surface with a different non-opaque material surface.

39. The combination work station for artwork and display device as in claim 1 wherein said at least one non-opaque material surface comprises a plurality of interchangeable non-opaque material surfaces, providing a means to change and re-use each of said non-opaque material surfaces.
